(19) United States
(12) Patent Application Publication
(10) Pub. No.: US 2026/0044903 A1
(43) Pub. Date: Feb. 12, 2026

(54) Machine-Learning Driven Recommendation Engine

(71) Applicant: Nayya Health, Inc., New York, NY (US)

(72) Inventors: Dionna JACOBSON, Brooklyn, NY (US); Brendan SHEEHAN, Astoria, NY (US); Michael TALARCZYK, Boonton, NJ (US); Ian MacDONALD, New York, NY (US); Leon KIRMAN, Jersey City, NJ (US); Renato Rangel Costa Cruz BOMFIM, Sao Paulo (BR)

(73) Assignee: Nayya Health, Inc., New York, NY (US)

(21) Appl. No.: 19/294,620

(22) Filed: Aug. 8, 2025

Related U.S. Application Data
(60) Provisional application No. 63/681,419, filed on Aug. 9, 2024.

(51) Int. Cl. G06Q 40/08; G06Q 10/1057

(52) U.S. Cl. CPC G06Q 40/0821; G06Q 10/1057; G06Q 40/09

(57) ABSTRACT

A data processing system implements a system for training and fine-tuning a plan recommendation model that recommends one or more insurance plans for a user based the cost of the insurance plans and the needs of the user. The plan recommendation model is trained and/or fine-tuned using training data that has been labeled by a human actuary to improve the accuracy of the model. The plan recommendation model is also fine tuned based on feedback received on recommendations made by the model to further improve the performance of the model.

### BACKGROUND

Recommending medical plans for an employee is complex, manual, and potentially error prone process. The employee may not have a complete understanding of the plans provided by their employer, and the employer is typically not in a position to assist the insured user in selecting a plan that meets the employee's needs. Consequently, the insured user may select an insurance plan that is inadequate for their needs. Hence, there is a need for improved systems and methods that provide a technical solution for solving the technical problem of automatically analyzing user requirements and suggesting an insurance plan that satisfies the user requirements.

### SUMMARY

An example data processing system according to the disclosure includes a processor and a memory storing executable instructions. The instructions when executed cause the processor alone or in combination with other processors to perform operations including accessing first insurance plan data from an insurance plan data store, the first insurance plan data identifying a plurality of first medical insurance plans provided by an employer to a plurality of first users of a benefits management platform; accessing first user data from a user information datastore, the first user data comprising information associated with a plurality of first users indicative of medical plan coverage needs of the plurality of first users; generating first candidate plan recommendations using a plan recommendation model, the plan recommendation model configured to identify one or more candidate medical insurance plans selected from among the plurality of first medical insurance plans for a selected user selected from among the plurality of first users based on user data associated with the selected user, each candidate plan recommendation including an indication of the selected user and indication of the one or more candidate medical insurance plans selected from among the plurality of first medical insurance plans; providing the first candidate plan recommendations to a first client device of an actuarial reviewer to present on an actuarial review user interface of the benefits management platform; receiving actuarial recommendations from the first client device, the actuarial recommendations comprising a recommended plan selected from the plurality of candidate medical insurance plans suggested by the plan recommendation model and a confidence score associated with the recommended plan; generating training data for the plan recommendation model based on the actuarial recommendations; fine-tuning the plan recommendation model using the training data; receiving a request for a plan recommendation from a second client device for a second user, the request for the plan recommendation requesting one or more medical insurance plans selected from among the plurality of first medical insurance plans based on second user data associated with the second user; providing the second user data as an input to the plan recommendation model to obtain second candidate plan recommendations; and sending the second candidate plan recommendations to the second client device to present on a plan recommendation user interface of the benefits management platform.

An example method implemented in a data processing system includes accessing first insurance plan data from an insurance plan data store, the first insurance plan data identifying a plurality of first medical insurance plans provided by an employer to a plurality of first users of a benefits management platform; accessing first user data from a user information datastore, the first user data comprising information associated with a plurality of first users indicative of medical plan coverage needs of the plurality of first users; generating first candidate plan recommendations using a plan recommendation model, the plan recommendation model configured to identify one or more candidate medical insurance plans selected from among the plurality of first medical insurance plans for a selected user selected from among the plurality of first users based on user data associated with the selected user, each candidate plan recommendation including an indication of the selected user and indication of the one or more candidate medical insurance plans selected from among the plurality of first medical insurance plans; providing the first candidate plan recommendations to a first client device of an actuarial reviewer to present on an actuarial review user interface of the benefits management platform; receiving actuarial recommendations from the first client device, the actuarial recommendations comprising a recommended plan selected from the plurality of candidate medical insurance plans suggested by the plan recommendation model and a confidence score associated with the recommended plan; generating training data for the plan recommendation model based on the actuarial recommendations; fine-tuning the plan recommendation model using the training data; receiving a request for a plan recommendation from a second client device for a second user, the request for the plan recommendation requesting one or more medical insurance plans selected from among the plurality of first medical insurance plans based on second user data associated with the second user; providing the second user data as an input to the plan recommendation model to obtain second candidate plan recommendations; and sending the second candidate plan recommendations to the second client device to present on a plan recommendation user interface of the benefits management platform.

An example machine-readable medium on which are stored instructions that, when executed, cause a processor of alone or in combination with other processors to perform operations of accessing first insurance plan data from an insurance plan data store, the first insurance plan data identifying a plurality of first medical insurance plans provided by an employer to a plurality of first users of a benefits management platform; accessing first user data from a user information datastore, the first user data comprising information associated with a plurality of first users indicative of medical plan coverage needs of the plurality of first users; generating first candidate plan recommendations using a plan recommendation model, the plan recommendation model configured to identify one or more candidate medical insurance plans selected from among the plurality of first medical insurance plans for a selected user selected from among the plurality of first users based on user data associated with the selected user, each candidate plan recommendation including an indication of the selected user and indication of the one or more candidate medical insurance plans selected from among the plurality of first medical insurance plans; providing the first candidate plan recommendations to a first client device of an actuarial reviewer to present on an actuarial review user interface of the benefits management platform; receiving actuarial recommendations from the first client device, the actuarial recommendations comprising a recommended plan selected from the plurality of candidate medical insurance plans suggested by the plan recommendation model and a confidence score associated with the recommended plan; generating training data for the plan recommendation model based on the actuarial recommendations; fine-tuning the plan recommendation model using the training data; receiving a request for a plan recommendation from a second client device for a second user, the request for the plan recommendation requesting one or more medical insurance plans selected from among the plurality of first medical insurance plans based on second user data associated with the second user; providing the second user data as an input to the plan recommendation model to obtain second candidate plan recommendations; and sending the second candidate plan recommendations to the second client device to present on a plan recommendation user interface of the benefits management platform.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1A is a diagram of an example model training pipeline according to the disclosure.

FIG. 1B is a diagram of an example plan recommendation pipeline according to the disclosure.

FIGS. 2A and 2B are diagrams showing an example computing environment that includes a benefits service platform that utilizes the model training pipeline shown in FIG. 1A and the plan recommendation pipeline shown in FIG. 1B.

FIG. 3 is a diagram of an example user interface of the employee portal shown in FIG. 2A.

FIG. 4 is a diagram of an example user interface of the employer portal shown in FIG. 2A.

FIG. 5 is a diagram of an example actuarial labeling interface shown in FIG. 1A.

FIG. 6 is a diagram of an example subject matter expert review interface shown in FIG. 2B.

FIG. 7 is a flow chart of an example process for operating a plan recommendation model according to the techniques disclosed herein.

FIG. 8 is a block diagram showing an example software architecture, various portions of which may be used in conjunction with various hardware architectures herein described, which may implement any of the described features.

FIG. 9 is a block diagram showing components of an example machine configured to read instructions from a machine-readable medium and perform any of the features described herein.

### DETAILED DESCRIPTION

Systems and methods are provided for training and fine-tuning a plan recommendation model that recommends insurance plans to a user based of the needs of the user. The systems and methods include a model training pipeline that provides a technical solution to the technical problem of recommending an insurance plan to a user of a benefits management platform. Current automated approaches to plan recommendations typically focus only on the cost of the plans, but this approach does not consider the overall needs of the insured user. The model training pipeline utilizes actuarial labeled training data to train and fine-tune the model so that the recommendations provided by the model mimic the plan recommendations that would be made by actuaries. Human actuaries consider a variety of factors when providing plan recommendations that are not limited solely to the plan cost. These factors can include but are not limited to the income of the insured user for whom the recommendations are being provided, the healthcare services utilized by the user and/or their family, the preferred medical providers and/or insurance network, pre-existing conditions of the insured user and/or their family, and numerous other factors that are used to select an insurance plan that balances costs and adequate coverage considerations to provide plan recommendations. A technical benefit of this approach is that using the actuarial labeled training data to train and/or fine-tune the plan recommendation model significantly improves the predictions generated by the plan recommendation model. Consequently, the computing resources utilized by the benefits management platform can be significantly decreased because the recommendations provided by the plan recommendation model will more closely align with the needs of the user and the user will not need to conduct numerous searches to compare the various plan options that are available to the user. Furthermore, as additional user data and/or insurance plan data is added to the system, additional actuary labeled training data can be generated to further fine-tune the performance of the plan recommendation model. Additional feedback can also be provided by subject matter experts that periodically review sample recommendations provided by the plan recommendation model which has been deployed to a production environment and provide feedback on these samples to further improve the recommendations provided by the plan recommendation model. A technical benefit of this approach is that the plan recommendation model can continue to evolve and adapt to changing user requirements even after the model has been trained using the actuarial labeled training data. These and other technical advantages of the techniques disclosed herein will be evident from the discussion of the example implementations that follow.

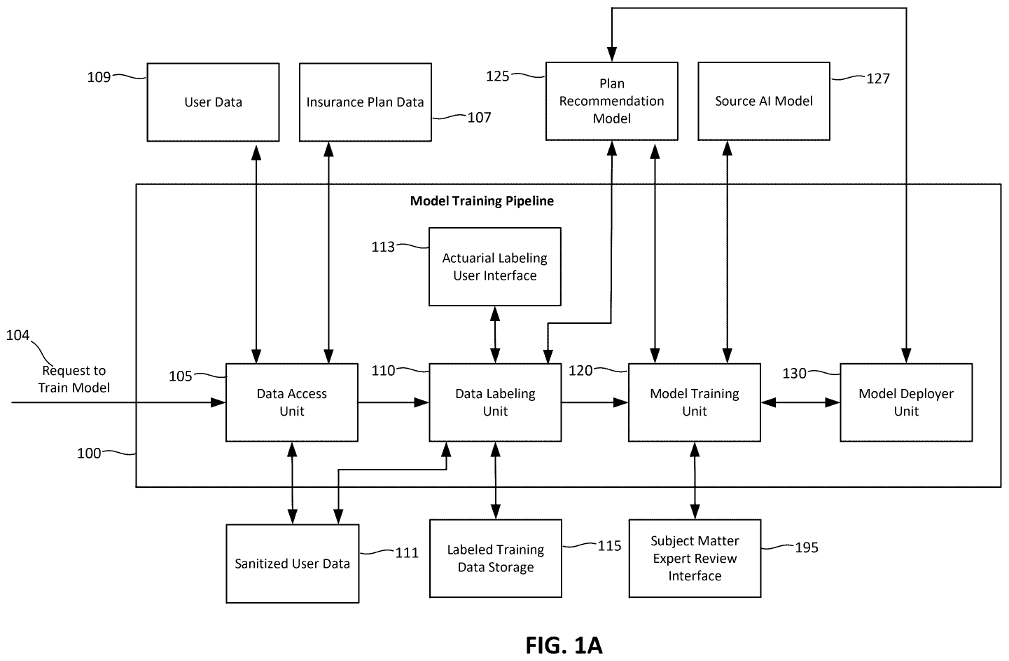

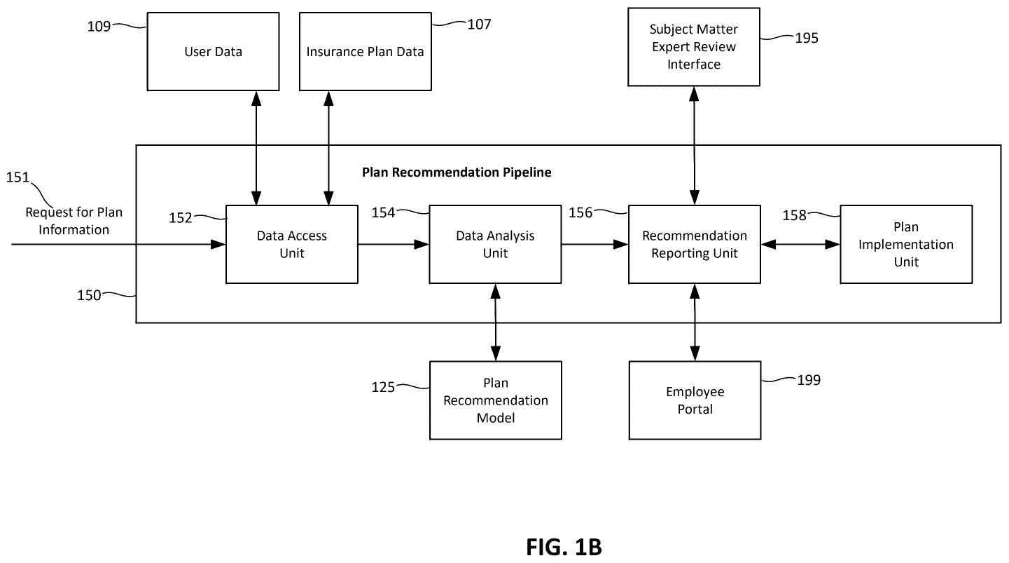

FIG. 1A is a diagram of an example model training pipeline 100 according to the disclosure. The model training pipeline 100 can be used to train a new instance of the plan recommendation model 125 and/or to fine-tune an instance of the plan recommendation model 125. The model training pipeline 100 can receive a request 104 to train the plan recommendation model 125 from an authorized administrator user who is authorized to initiate the training of a new instance of the model training pipeline 100 or to fine-tune an instance of the plan recommendation model 125. The data access unit 105 receives the request and accesses the user data 109. The data access unit 105 accesses insurance plan data 107 from an insurance plan data store. The insurance plan data 107 identifies medical insurance plans provided by an employer to employees via a benefits management platform. The employees can select from among these medical insurance plans to provide coverage for various types of medical expenses incurred by the employees.

The data access unit 105 accesses user data from a user information datastore. The user information datastore is a persistent datastore in memory of a computing environment in which the model training pipeline 100 is implemented. The user data includes information associated with users of the benefits management platform that is indicative of medical plan coverage needs of the users. The user data 109 can include but is not limited to information about the user and others who may be covered by their insurance. For instance, the user data can include information about the user, a spouse, and dependent children. The user data can also include additional information, such as the age, gender, geolocation and other information about the user and/or other covered persons. The user data can include financial information, such as but not limited to the annual income of the user, any bonus that that user may receive, and/or any spousal income. The financial information can also include savings information indicates savings that the user could utilize to pay for medical expenses that are not covered by their insurance. The savings information can include information that indicates whether the user has a health savings account (HSA), a Flexible Spending Account (FSA), and/or a Health Reimbursement Agreement (HRA) that can be used to cover at least a portion of the medical expenses incurred by the user and/or insured dependents. The user data can also include an indication of the risk aversion of the user, which provides an indication whether the user prefers savings with respect to insurance costs or prefers higher protection that is likely to cover more medical expenses incurred by the insured user or their dependents. The user data can include historical utilization of health services by the user and/or the insured dependents of the user. For instance, this historical utilization information can include a number of primary care physicians (PCPs) within a specified period of time (i.e., the past 12 months), a number of specialist visits within the specified period of time, pre-existing health conditions, and/or prescriptions prescribed within the specified period of time. The prescription information can also include information for medications that the user and/or a covered family member will continue to rely on indefinitely or for at least a period of time during which the plan will cover the user and/or the user's family. The historical health information can also include the healthcare PCP and/or specialists seen by the insured user and/or their dependents and an indication of how important to the user that the PCP and/or specialists accept any insurance plans recommended to the user. The user data can include qualifying life events (QLE) information that indicates a significant change in the insured user's life that enables the user to enroll in and/or modify their health insurance coverage outside of the standard open enrollment period. Examples of such QLEs include but are not limited birth or adoption of a child, change in marital status, and/or other such events that would permit the user to update their insurance coverage outside of the regular open enrollment period.

The data access unit 105 can analyze the user data and sanitize the user data 109 to remove personally identifiable information (PII) from the user data 109 before utilizing the data in the process of generating the training data for the plan recommendation model 125. The PII can be masked, truncated, and/or replaced with synthetic data that is not based on the user data 109. The data access unit 105 sanitizes the user data 109 to ensure that the no sensitive user data is disclosed to the human actuaries that review plan recommendations to be included in the training data or that no sensitive user data is included in the training data. A technical benefit of this approach is that the training process complies with data security and/or data privacy rules, regulations, and/or industry standards to ensure that no sensitive user data is disclosed while generating labeled training data and training the plan recommendation model 125 using real user data. Consequently, the actuarial labeled training data used to train the model is based on real-world data that the plan recommendation model is likely to encounter to train the model to provide plan recommendations that mimic those that an actuary would recommend given similar user data. The data access unit 105 stores the sanitized user data 111 in a persistent datastore.

The data access unit 105 accesses insurance plan data 107 from an insurance plan data store. The insurance plan datastore is a persistent datastore in memory of a computing environment in which the model training pipeline 100 is implemented. The insurance plan data 107 identifies medical insurance plans provided by an employer to the employee users of a benefits management platform. The insurance plan information includes information indicating the types of expenses covered by each of the medical insurance plans and the costs associated with each of the plans. The costs can include but are not limited to the employee contribution that would be paid by the insured user to cover the user and/or the user's dependents. The insurance plan information can also include an indication of which health network or provider network is associated with the plan. The health network information can be used to determine whether a PCP and/or specialist associated with the user would be in network or out of network, which can significantly impact the costs associated with obtaining medical treatment from the PCP and/or specialist.

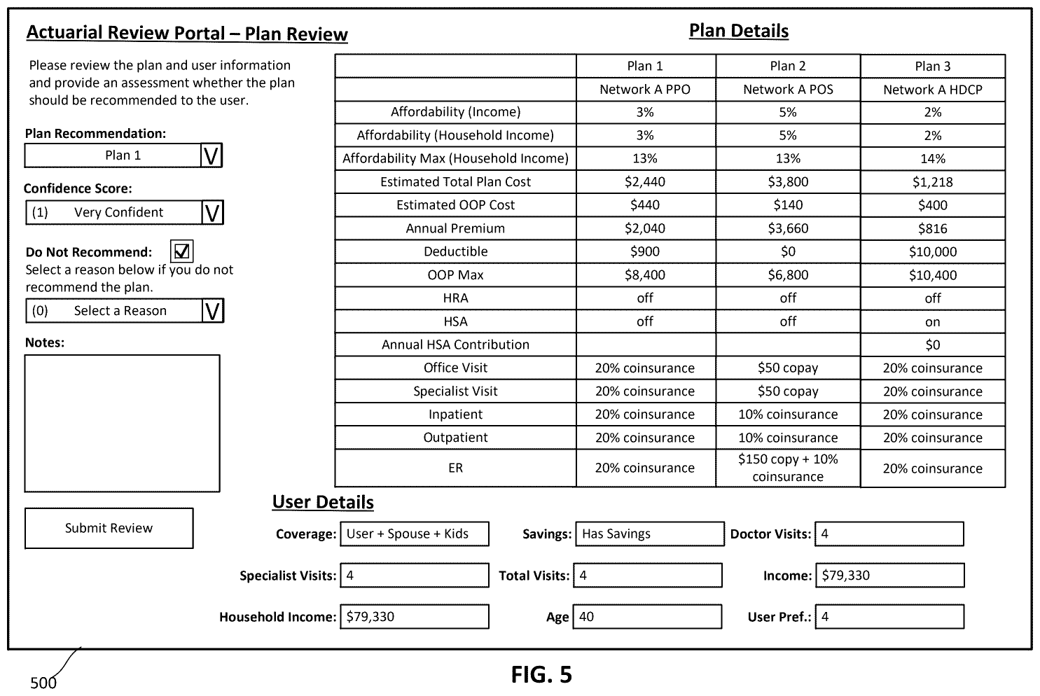

The data access unit 105 provides the insurance plan data 107 and the sanitized user data to the data labeling unit 110. The data labeling unit 110 generates candidate plan recommendations using the plan recommendation model 125. The plan recommendation model 125 is a machine learning model that is trained to identify one or more candidate medical insurance plans selected from among the medical insurance plans included in the insurance plan data 107 for a user selected from among the plurality of first users based on the user data associated with the selected user from the user data 109. Each plan recommendation includes an indication identifying the selected user and indication of the one or more candidate medical insurance plans selected from among the plurality of first medical insurance plans recommended to the user based on the user data for the user. The candidate plan recommendations are presented to human actuaries for analysis. The human actuaries analyze the candidate plan recommendations to determine whether the plans recommended by the plan recommendation model 125 are relevant to the user based on the user's profile represented in the user data. The data labeling unit 110 provides the candidate plan recommendations to the client device of one or more actuarial reviewers. The candidate plan recommendations are presented on an actuarial labeling user interface 113 of the benefits management platform. An example of such an actuarial labeling user interface 500 is shown in FIG. 5, which is discussed in detail below.

The human actuaries can review the recommended plans using the following labeling guidelines when assessing whether the plan recommendation model 125 has recommended plans appropriate for the user. The actuary uses the criteria set forth in the labeling guidelines when providing feedback on the plan recommendations output by the plan recommendation model 125.

One of the criteria of the labeling guidelines is the affordability of a recommended plan. The affordability of a recommended plan is determined based on an affordability threshold. The affordability threshold can be expressed as the total plan cost as a percentage of the insured user's income. For instance, the affordability threshold in some implementations is set to 15%, which indicates that the total plan cost should not exceed 15% of the insured user's income in order for the plan to be considered affordable. In some implementations, a first affordability threshold can be set based on the user's individual income and a second affordability threshold set based on the user's household income where the individual income and the household income differ. For example, the first affordability threshold might be set to 20% and the second affordability threshold set to 15%, which indicates that the total plan cost should not exceed 20% of the insured user's income and should not exceed 15% of the household income.

The total plan cost can be expressed as the premium paid by the user plus any out-of-pocket costs that have been input by the user. Any employer contributions to an HSA, FSA, or HRA are subtracted from the premium paid and out-of-pocket costs. If the out-of-pocket costs and/or the employer contribution information is unavailable, the affordability threshold can be selected from among the following cost options: (1) the plan premium, (2) the plan premium+deductible (single or family), or (3) the plan premium+the out-of-pocket maximum (single or family). The cost option can be selected based on the medical services utilization input by the user. If the user has not input any medical services utilization information or zero values for the medical services utilization, cost option (1) is selected. Otherwise, cost option (2) or (3) can be selected based on the medical services utilization provided by the user.

Any user who is recommended a plan that exceeds the affordability threshold is considered to be unaffordable and the user would be considered underinsured. Underinsured, as used herein, indicates that the insurance plan is inadequate for the user's healthcare needs, so the costs of the healthcare would be a financial burden on the user. Other metrics can also be used in other implementations to determine whether the user in underinsured. Plans that exceed the affordability threshold should only be recommended by the actuaries if there are not any more affordable plans. In such instance, the most affordable plan or the plan closest to the affordability threshold is selected to be recommended to the user.

Additional factors that can be considered when determining the affordability of a plan can include prescription costs and user contributions to health spending accounts (FSA, HSA, HRA). A maximum prescription cost threshold can be set as a percentage of the insured user's annual or monthly income can be set. For instance, in a non-limiting example, the maximum prescription cost threshold can be set to 5% of the insured user's monthly income when considering the affordability of the plan. The user contributions to the health spending accounts should also not exceed the maximum health spending account contribution threshold. The health spending account contributions contribute to the overall out of pocket expenses for the insured user. The maximum health spending account contribution threshold can vary depending upon the user preferences for risk and spending. For instance, in a non-limiting example, the maximum health spending account contribution threshold can be set to 5% to 10% of the insured user's monthly income. The monthly cost associated with the plan can be determined to be the cost of one month of prescriptions for the insured user and/or their family plus one-twelfth of the deductible costs for the year plus the monthly plan premium for the plan less any monthly health spending account contributions.

An additional factor when making plan recommendations is how much a recommended plan exceed the cost of the most affordable plan being recommended. The affordability range can be expressed as a percentage of the cost of the most affordable claim. In a non-limiting example, the affordability range is 5% and plans that are more than 5% more expensive that the most affordable plan should not be recommended to the user. Plans that fall within the affordability range can be ranked based on the cost, user preferences, and scores associated with the insurance providers offering those plans.

Another of the labeling criteria considered by the actuaries include medical plan utilization provided by the user. Utilization by the user provides an insight into the medical insurance coverage needs of the user. The data labeling unit 110 can calculate several estimates associated with utilization that can be used by the actuaries to assess whether a particular plan suggested by the plan recommendation model 125. The values can include but are not limited to: Projected Non-Insurance Out of Pocket Costs (NIOPC), Projected Annual Prescription Drug Costs, Projected Monthly Prescription Drug Costs. The cost estimates can be used to categories the user into one a predetermined set of utilization categories. In a non-limiting example, the utilizations categories include: (1) a “No Utilizer” category that spends approximately $0 to $500 annual medical costs; (2) a “Low Utilizer” category that spends approximately $501 to $1,000, (3) a “Medium Utilizer” category that spends approximately $1,001 to $3,000, and (4) a “High Utilizer” category that spends approximately $3,001 to $10,000, and (5) an “Extreme Utilizer” category that spends approximately $3,001 to $10,000. Users that fall into the “High Utilizer” and the “Extreme Utilizer” categories should typically not be recommended HAS eligible plans. Users that fall into the “No Utilizer” category should typically be recommended the lowest cost plan. However, when the lowest cost plan does is not HSA eligible, the lowest cost HSA eligible plan should be recommended if any additional cost for the plan premium for the HSA eligible does not exceed a predetermined cost threshold.

Another of the labeling criteria considered by an actuary is savings and premium preferences provided by the user. The insured user can specify how the user would pay for an unexpected medical bill, especially with high deductible plans. The actuary considers this factor when determining whether a plan recommended by the plan recommendation model 125 is appropriate for the user. In a non-limiting example, the user can provided one of four response categories indicating how the user would pay for the unexpected medical expense: (1) borrow money-recommendations should skew away from High Deductible Health Plans (HDHP) if the user would borrow money; (2) has savings-minimal impact on health plan selection; (3) HSA account-recommend a HSAA eligible plan; or (4) “I don't know”-treat this category similarly to the borrow money category and avoid plans with higher deductibles. The savings and premium preferences are typically not the highest consideration when labeling a plan. Instead, the savings and premium preferences can be used as a tie breaker where multiple plans could be recommended to the insured user based on the other criteria discussed.

Another of the labeling criteria considered by the actuaries is network and/or preferences provided by the user and the network strength and the number of selected providers in the user's geographical area. The network strength represents how many providers in each network for a particular plan categorized as a proportion of the total providers. If the number of providers for a particular area is less than a minimum provider threshold, the network strength is set to zero. The number of selected providers in network is expressed as a count of the user's select providers. These values will be zero if the user has not identified any selected providers. Plans with no or fewer than a minimum threshold should not be considered or recommended to the user if there are other plans with providers in the geographical area of the user. Plans having the same or similar network strength, within the same category, the network strength has no impact on plan choice. For plans having different network strengths but similar affordability and utilization, the plan having a higher network strength should be recommended. For selected network providers, if plans have a similar affordability and utilization but different numbers of selected in-network providers, the plan having a higher number of in-network providers should be recommended.

The data labeling unit 110 receives actuarial recommendations from the client devices of the actuarial users. The actuarial recommendations include a recommended plan selected from the plurality of candidate medical insurance plans suggested by the plan recommendation model and a confidence score associated with the recommended plan. The data labeling unit 110 generates training data for the plan recommendation model 125 based on the actuarial recommendations. The training data includes a plurality of samples. Each sample includes the sanitized user data of the user for which the plan recommendations were provided, the recommended plan selected by the actuary, and a confidence score in the selection provided by the actuary. The confidence score indicates how certain the actuary is that the recommended plan is the best plan from among the plurality of plans recommended by the plan recommendation model 125. The actuarial recommendations can also identify candidate plans that should not have been recommended by the plan recommendation model 125 based on the user data of the insured user for which the recommendations were generated. Including such negative examples helps to fine-tune the plan recommendation model 125 to avoid recommending similar plans to users having similar user data. The data labeling unit 110 can store the labeled training data in a labeled training data storage 115, which is implemented in a persistent memory of the computing environment associated with the model training pipeline 100. The stored data can be later used to train or refine the training of an instance of the plan recommendation model 125.

The model training unit 120 uses the training data generated by the data labeling unit 110 to fine tune an instance of the plan recommendation model 125. The instance of the plan recommendation model 125 can be the same instance of the plan recommendation model 125 that was used by the data labeling unit 110 to generate the candidate plan recommendations that were analyzed by the actuaries. In some implementations, the model training unit 120 trains a new instance of the plan recommendation model 125 from a source AI model 127 that has not yet been trained or finetuned to generate the plan recommendations. The architecture of the plan recommendation model 125 and the source AI model 127 can vary from implementation to implementation. In some implementations, the plan recommendation model 125 and the source AI model 127 can be implemented using artificial neural network (ANN) architectures, such as but not limited to feedforward neural networks (FNNs), convolutional neural networks (CNNs), and recurrent neural networks (RNNs). Other implementations can utilize other model architectures.

The model training unit 120 can reserve at least a portion of the training data generated by the data labeling unit 110 for validating the performance of the plan recommendation model 125. The model training unit 120 can provide the user data from the training data as an input to the plan recommendation model 125 to obtain an example output from the plan recommendation model 125. The model training unit 120 can then compare the example output with the actuarial recommendation data to determine whether the plan recommendation model 125 recommended a plan that was similar to one recommended by the actuary for that sample. The model training unit 120 can aggregate the results of testing each of the validation portion of the training data and determine whether the performance of the fine-tuned version of the plan recommendation model 125 is performing better than a previous version of the plan recommendation model 125. To make this determination, the model training unit 120 can compare the results of processing the same set of validation training data on the plan recommendation model 125 prior to fine-tuning the training of the model with the training data to determine whether there was an improvement in the performance of the model. The model training unit 120 can use various statistical analysis techniques to make this determination whether the performance of the fine-tuned version of the plan recommendation model 125 performed better than the previous version of the model. The model training unit 120 can provide an indication to the model deployer unit 130 that indicates that the fine-tuned version of the plan recommendation model 125 performed better than the previous version of the model. The model deployer unit 130 can deploy the fine-tuned version of the plan recommendation model 125 to a production computing environment in which the plan recommendation model 125 can be utilized by the plan recommendation pipeline 150 shown in FIG. 1B to generate recommendations for plans for users of a benefits management platform.

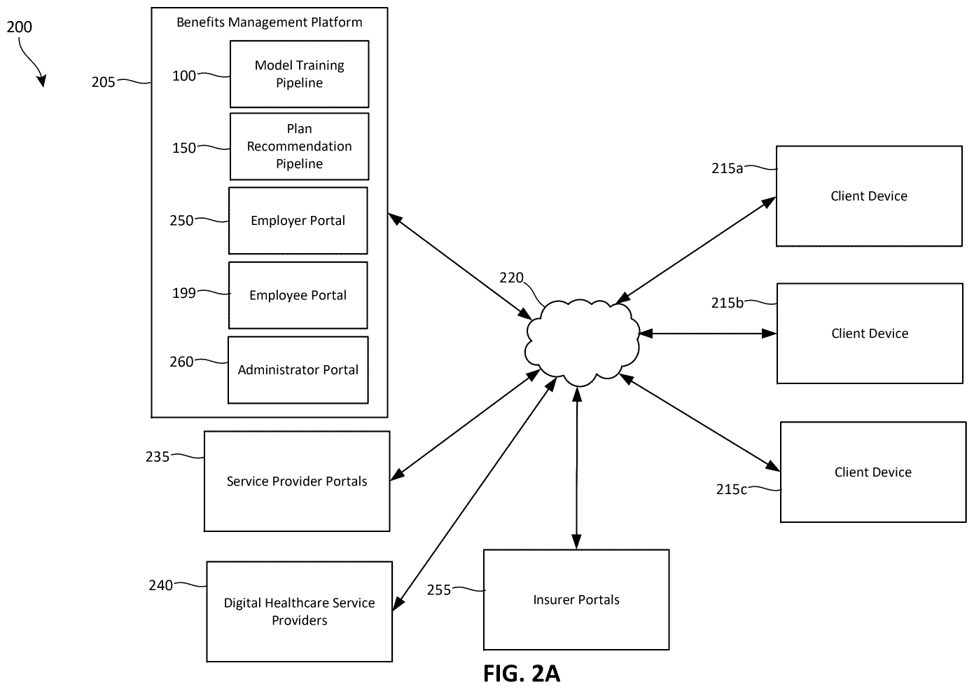

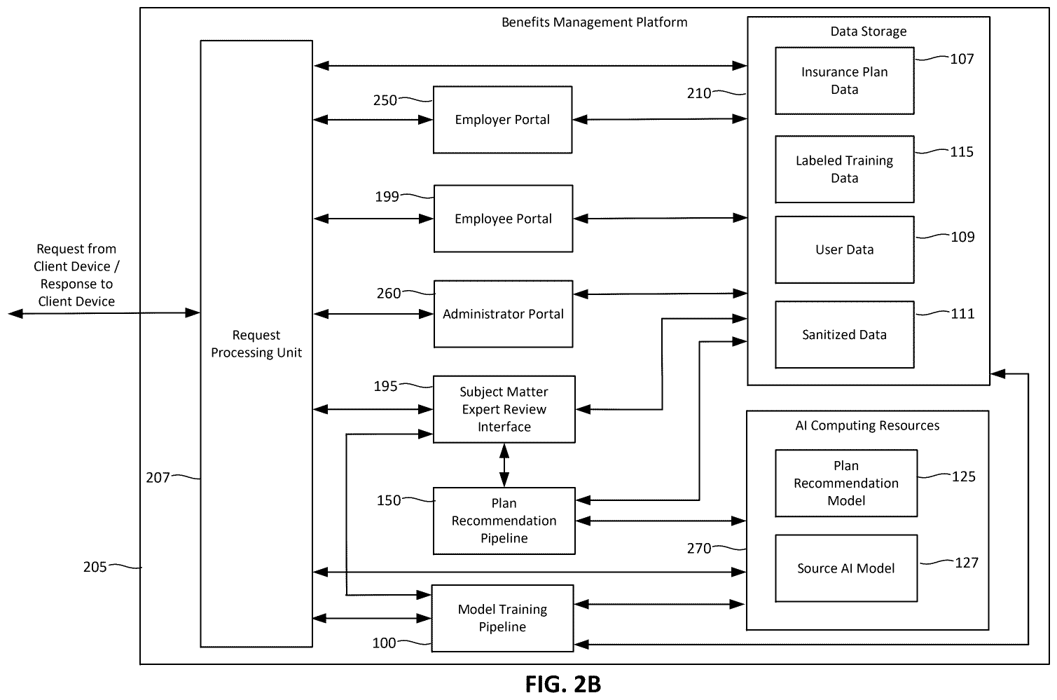

FIG. 1B is a diagram of an example implementation of a plan recommendation pipeline 150 according to the disclosure. The plan recommendation pipeline 150 can be implemented by a benefits management platform that enables employers to obtain and manage benefits for their employees and enables the employes to manage and utilize these benefits. The plan recommendation pipeline 150 receives a request 151 from a user interface of an employee portal 199 which enables employee users to access and manage their benefits on the benefits management platform. Additional details of the employee portal 199 are discussed with respect to FIG. 2A below.

The data access unit 152 receives the request 151. The request 151 is a request to generate medical plan recommendations for a user of the benefits management platform. The request 151 includes a user identifier associated with the user, and the data access unit 152 accesses the user data 109 to obtain the user data associated with the user for which the plan recommendation is to be made. The data access unit 152 also access the insurance plan data 107 which includes the medical plans offered by the employer that can be recommended to the user by the plan recommendation model 125.

The user data and the plan data are provided to the data analysis unit 154 which provides the user data and the insurance plan data as an input to the plan recommendation model 125 to obtain one or more candidate plan recommendations. The data analysis unit 154 constructs a prompt from the user data and the insurance plan data in some implementations that instructs the plan recommendation model 125 to analyze the user data and the insurance plan data to provide one or more candidate plan recommendations to present to the user. The one or more candidate plan recommendations are provided to the recommendation reporting unit 156.

The recommendation reporting unit 156 provides the one or more candidate plan recommendations to the employee portal 199 to present on a user interface of the employee portal so that the user can review the one or more candidate plan recommendations. The recommendation reporting unit 156 can also provide the one or more candidate plan recommendations to the subject matter expert review interface 195. The subject matter expert review interface 195 can be implemented by an administrator portal of the benefits management platform. The subject matter expert review interface 195 enables an administrator to review the recommendations that have been output by the plan recommendation model 125 and to provide feedback on the recommendations that can be used to further fine-tune the performance of the plan recommendation model 125. The subject matter expert review interface 195 enables an administrator that is familiar with the health plans being offered by the employer to make a determination whether the output of the model appears to be correct based on the recommendation criteria discussed above. The subject matter expert review interface 195 includes a first control, which when clicked on or otherwise activated by the subject matter expert, causes the administrator portal to provide feedback to the model training pipeline 100 indicating that the plan recommendation model 125 correctly suggested one or more plans to the user. The subject matter expert review interface 195 includes a second control, which when clicked on or otherwise activated by the subject matter expert, causes the administrator portal to provide feedback to the model training pipeline 100 indicating that the plan recommendation model 125 incorrectly suggested one or more plans to the user. The feedback is used by the model training unit 120 to further refine the training of the plan recommendation model 125. In some implementations, the feedback is stored in a feedback datastore (not shown) that is periodically accessed, and the feedback is analyzed by the model training unit 120.

The employee user can select a plan that has been recommended by clicking on or otherwise activating a control on the user interface of the employee portal, and the employee portal sends an indication to the recommendation reporting unit 156 that the user has selected a particular plan. The recommendation reporting unit 156 provides this indication to the plan implementation unit 158, which provides a user interface that enables the user to enroll in the plan online and/or to fill out and generate enrollment forms that can be sent electronically to the insurance provider or employer and/or printed and mailed to the insurance provider or employer.

FIGS. 2A and 2B are diagrams showing an example computing environment 200 that includes a benefits management platform 205 that utilizes the model training pipeline 100 shown in FIG. 1A and the plan recommendation pipeline 150 shown in FIG. 1B. The benefits management platform 205 is a cloud-based service that provides tools for employers to manage benefits provided to employees and tools for the employees to access and utilize these benefits. The network 220 provides a means for communication among the various elements of the computing environment 200. The network 220 can include one or more wired and/or wireless public networks, private networks, or a combination thereof. The network 220 may be implemented at least in part by the Internet.

The benefits management platform 205 provides an employer portal 250 that provides a dashboard user interface that enables employers to access information associated with the insurance plans and benefits provided to their employees. These benefits may include insurance policy information as well as information about service providers with which the employer may have contracted to provide services to the employee. These services may include services provided by one or more digital healthcare service providers. The employer portal 250 provides user interfaces for viewing, accessing, or modifying the services that the employer has obtained on behalf of their employees. The employer may cover all or part of the cost associated with the services provided by the digital healthcare service providers. The employer portal 250 includes a search interface for the employer to search for insurers and/or digital healthcare service providers and obtain insurance plan information and/or service plan information from the insurers and/or digital healthcare service providers. The employer portal 250 provides tools that guide the employer through setting up new insurance coverage and/or a new service plan with an insurer and/or a digital health service provider. The plan information is stored as the insurance plan data 107 discussed in the preceding examples. The employer portal 250 also provides a user interface that enables the employer to add employee information, which can be stored as at least a part of the user data 109 discussed in the preceding examples.

The employee portal 199 provides a dashboard user interface that enables employees to access information associated with the benefits provided by their employer, information about insurance claims and prescriptions for the user and/or others covered by the user's insurance, information on benefits utilization and how the user may save money by adjusting how they utilize their benefits. The employee portal 199 can also provide the user with access to the digital health services provided by the digital healthcare service providers 240, such as telehealth services, patient monitoring, and/or other services that the user can access remotely. The employee portal 199 can provide a user interface that enables the user to search for medical plans recommended by the plan recommendation pipeline 150. The employee portal 199 can also include user interfaces that enable the user monitor insurance claims for medical and/or pharmaceutical services. The employee portal 199 can also provide a user interface that enables the user to enroll in an insurance plan, to submit claims to insurers, and/or review reimbursement opportunities for claims that have not yet been reimbursed.

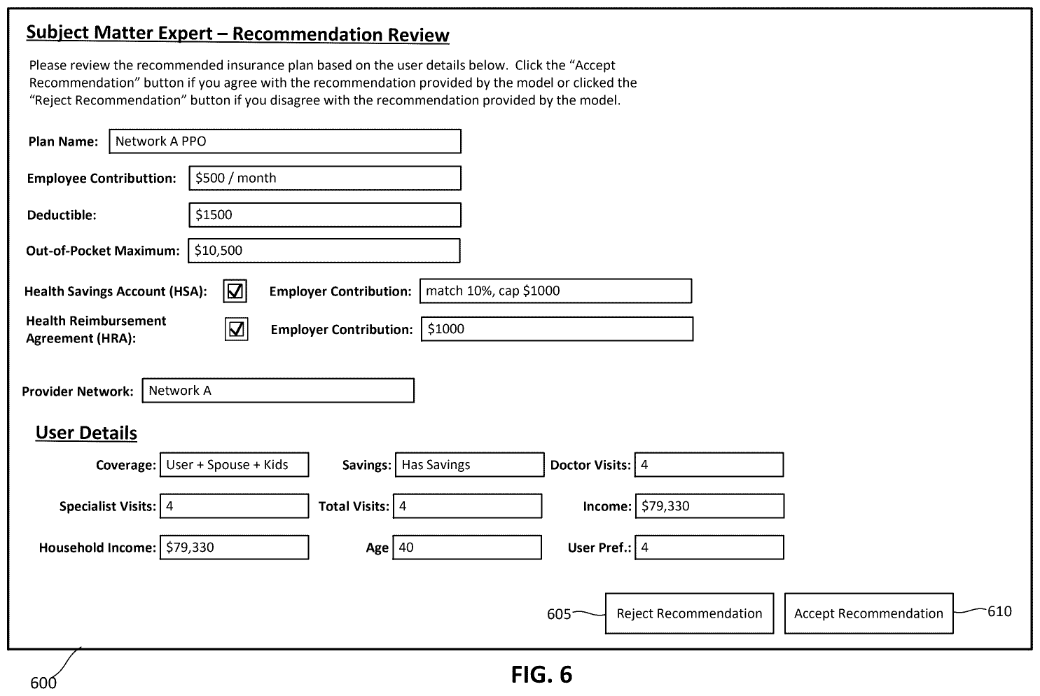

The administrator portal 260 provides a dashboard user interface that enables administrators and/or other authorized users to configure features of the benefits management platform 205. The administrator portal 260 can provide user interfaces that enable the administrators to add new employers to the platform, remove existing employers from the platform, configure the tools available to existing employers, and/or perform other administrative actions on the benefits management platform 205. The administrator portal 260 can also provide user interfaces that enable an administrator to request that the model training pipeline 100 train an instance of the plan recommendation model 125 and/or fine-tune an instance of the plan recommendation model 125. The administrator portal 260 can also implement the actuarial labeling user interface 113 of the model training pipeline 100 and/or the subject matter expert review interface 195. An example of the actuarial labeling user interface 113 is shown in FIG. 5, and an example of the subject matter expert review interface 195 is shown in FIG. 6.

The service provider portals 235 provide tools that enable medical service providers, such as but not limited to doctors, dentists, optometrists, pharmacies, and/or other medical professionals to submit medical and/or pharmaceutical claims to the insurers on behalf of an insured user. The service provider portals 235 can include tools for providers to check the status of a claim with an insurer. The service provider portals 235 may also permit the providers to amend and/or resubmit claims.

The digital healthcare service providers 240 provide digital healthcare point solutions. The digital healthcare service providers 240 can contract with employers to provide their services to employees of the employers. The digital healthcare service providers 240 can also provide these services to individual users requiring such services. The digital healthcare service providers 240 can provide a virtual clinic that users can access from a smart phone, tablet, computer, or other such client devices. The digital healthcare service providers 240 may provide various types of telemedicine services, counseling, and guidance to users. This approach enables the digital healthcare service providers 240 to provide high quality care to users regardless of the geographical location of the providers and the users. Consequently, the digital healthcare service providers 240 may provide such services at a significantly lower cost than traditional healthcare providers, which bear the significant cost of brick-and-mortar physical locations for their offices and/or clinics. The digital healthcare service providers 240 can submit medical and/or pharmaceutical claims to the insurance policy or polices of an insured employee.

The insurer portals 255 provide an interface for accessing insurance policy information for primary health insurance policies, supplemental health insurance policies, and/or other types of insurance policies provided by the insurers. The insurer portals 255 can provide tools that enable insured users to access policy information, make policy payments, obtain new policies, submit claims on existing policies, and/or perform other actions related to the managing the insured's insurance. In some instances, the employer subsidizes all or a least a portion of the cost of the insurance and is responsible for making policy payments. The insurer portals 255 can also provide an interface that enables the benefits management platform 205 to access the policy information for insured users that have provided consent to access their policy information and/or to permit the employee portal 199 and/or the benefits management platform 205, and/or other benefits management tools to submit claims on behalf of the insured users. The insurer portals 255 can also provide an interface that enables the components of the benefits management platform 205 to access electronic policy information for insured users, download the electronic policy information, map the electronic policy information to a data format according to the standard scheme utilized by the benefits management platform 205, and to store the formatted policy information in the insurance plan data 107 in a memory associated with the benefits management platform 205.

The client devices 215a, 215b, and 215c are computing devices that can be used to access the services provided by the benefits management platform 205, the insurer portals 255, the service provider portals 235, and/or the digital healthcare service providers 240. The client devices 215a, 215b, and 215c can have various form factors. For instance, the client devices 215a, 215b, and 215c can be implemented as a portable electronic device, such as a mobile phone, a tablet computer, a laptop computer, a portable digital assistant device, a portable game console, and/or other such devices. The client devices 215a, 215b, and 215c can also be implemented in computing devices having other form factors, such as a desktop computer, vehicle onboard computing system, a kiosk, a point-of-sale system, a video game console, and/or other types of computing devices. While the example implementation illustrated in FIG. 2A includes three client devices, other implementations may include a different number of client devices.

FIG. 2B shows additional details of the benefits management platform 205. The request processing unit 207 receives requests from a client device, such as the client devices 215a, 215b, and 215c to access the various services provided by the benefits management platform 205. The user may access services provided by the benefits management platform 205 via a native application implemented on the client device or via a web application implemented on the benefits management platform 205 and accessed from a browser application on the client device. The request processing unit 207 receives the requests from the client device, provides the request to the appropriate component of the benefits management platform 205 for processing, receives a response from the component of the benefits management platform 205, and provides the response to the client device. The request processing unit 207 can also coordinate communication and exchange of data among components of the benefits management platform 205.

The AI computing resources 270 provide a computing environment that allocates and manages computing resources and memory for one or more AI models. In the example implementation shown in FIG. 2B, the AI computing resources 270 includes the plan recommendation model 125 and the source AI model 127. In some implementations, the AI computing resources 270 can implement multiple instances of the plan recommendation model 125. For instance, the AI computing resources 270 can provide one or more versions of the plan recommendation model 125 that are being trained and/or fine-tuned and/or one or more version of the plan recommendation model 125 that have been deployed and are being utilized to provide plan recommendations. Some implementations of the model training pipeline 100 train an instance of the plan recommendation model 125 for each employer so that the model is customized for the specific needs of the employe users of that employer.

The data storage 210 provides persistent storage for the insurance plan data 107, the labeled training data storage 115, the user data 109, and the sanitized user data 111. The insurance plan data 107, the labeled training data storage 115, the user data 109, and the sanitized user data 111 for each employer is segregated from the data of other employers to ensure data privacy and security are maintained.

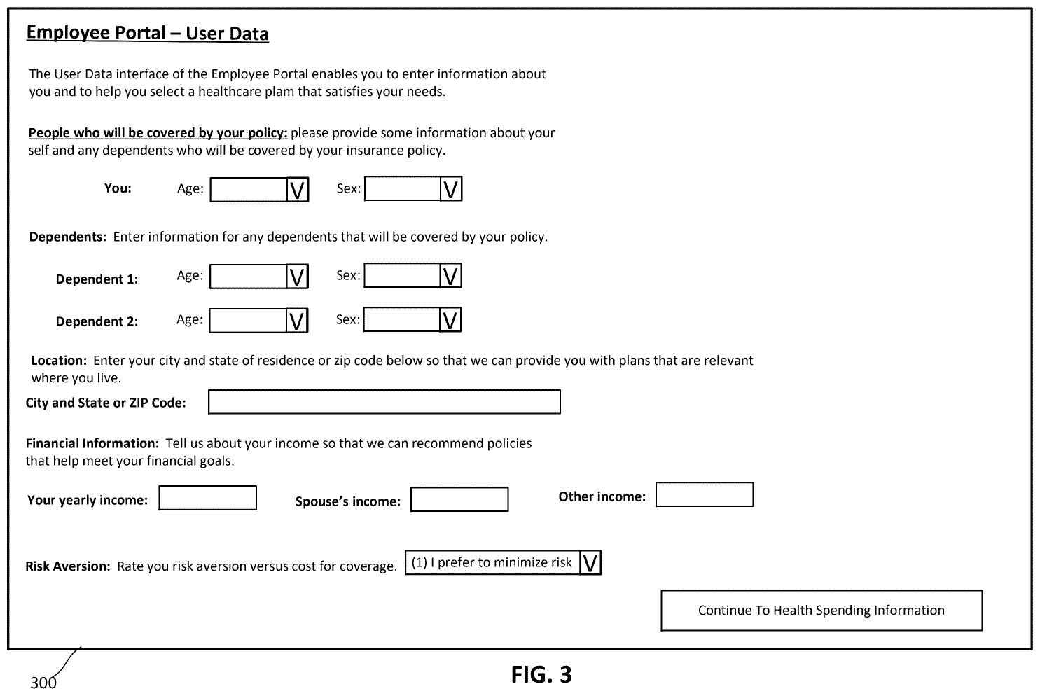

FIG. 3 is a diagram of an example user interface 300 of the employee portal 199 shown in FIGS. 2A and 2B. The user interface 300 enables the user to input user data about the insured user and the user's spouse and/or children where appropriate. The user interface 300 can be implemented by a native application the client device of the user and/or implemented by a web application associated with the benefits management platform 205. The employee portal 199 stores the information input by the user as user data 109. The employee portal 199 can also provide other user interfaces in addition to the user interface 300. For instance, the employee portal 199 can provide a user interface that enables the user to request plan recommendations, to review the plan recommendations provided by the plan recommendation pipeline 150, and to enroll in one of the recommended plans.

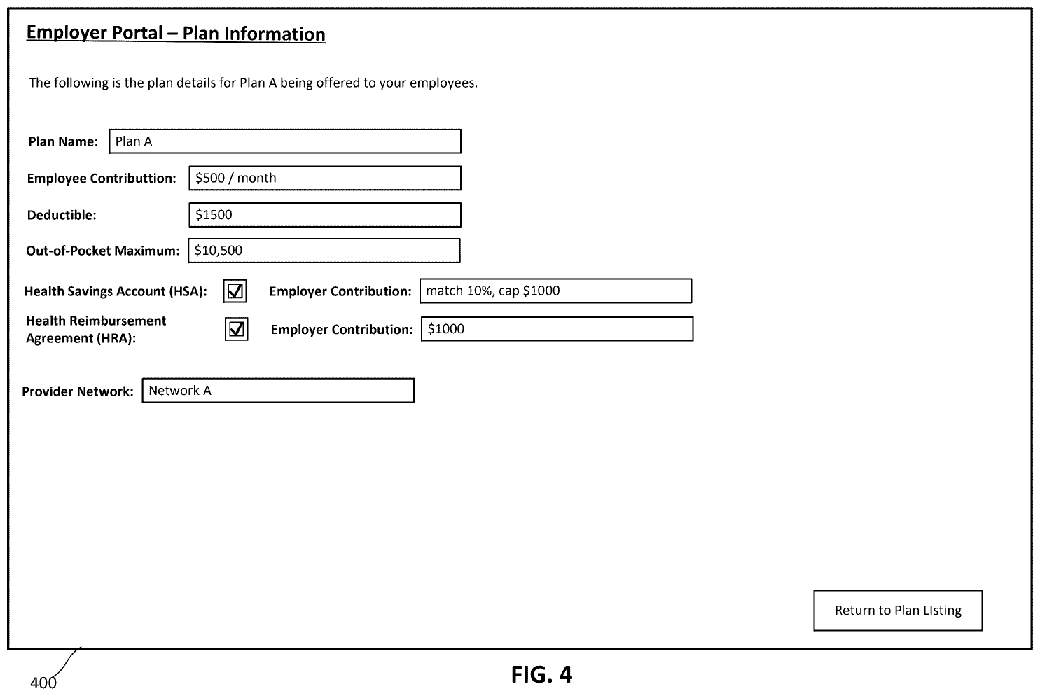

FIG. 4 is a diagram of an example user interface 400 of the employer portal 250 shown in FIG. 2A. The user interface 400 enables the employer to view the details of one of the plans offered to their employees. The user interface 400 can be implemented by a native application the client device of the user and/or implemented by a web application associated with the benefits management platform 205. The employer portal 250 can also provide other user interfaces. For instance, the employer portal 250 can provide user interface that enable the employer to add, modify, or remove employee information, to add, modify, or remove plan information, and to search for and select plans provided by insurance providers.

FIG. 5 is a diagram of an example actuarial labeling user interface 500 that can be used to implement the actuarial labeling user interface 113 shown in FIG. 1A. The actuarial labeling user interface 500 can be implemented by the administrator portal 260. The user interface 400 can be implemented by a native application the client device of the user and/or implemented by a web application associated with the benefits management platform 205. The actuarial labeling user interface 500 enables an actuary to provide feedback on plan recommendations that output by the plan recommendation model 125. The user interface includes affordability features derived from the user data and the plan information. For example, the actuarial labeling user interface 500 can provide affordability information that provide an indication of the percentage of the user's income needed to pay the plan cost, the user's household income needed to pay the plan cost, and a maximum percentage of the household income that the user could spend on plan costs. The data labeling unit 110 of the model training pipeline 100 can determine the affordability information that is provided on the actuarial labeling user interface 500.

In the example implementation shown in FIG. 5, the actuary can select a plan from among a set of plans recommended by the plan recommendation model 125 that the actuary determines is the best plan to recommend to the user based on the user data and the plan information. The actuary can also input a confidence score. The confidence score indicates how certain the actuary is that the recommended plan is the best plan from among the plurality of plans recommended by the plan recommendation model 125. The actuarial recommendations can also identify candidate plans that should not have been recommended by the plan recommendation model 125 based on the user data for the user for which the recommendations were generated. Including such negative examples helps to fine-tune the plan recommendation model 125 to avoid recommending similar plans to users having similar user data.

FIG. 6 is a diagram of an example subject matter expert review interface 600 that can be used to implement the by the subject matter expert review interface 195 shown in FIG. 2B. The subject matter expert review interface 600 can be implemented by the administrator portal 260. The user interface 400 can be implemented by a native application the client device of the user and/or implemented by a web application associated with the benefits management platform 205. The subject matter expert review interface 600 enables a subject matter expert to review a plan that was recommended by the plan recommendation model 125 for a specific user. The subject matter expert review interface 600 can be utilized during the training and/or fine-tuning of the plan recommendation model 125 to enable a subject matter expert to provide feedback on the plans that have been recommended by plan recommendation model 125. The subject matter expert review interface 600 can also be used to review recommendations that have been made the plan recommendation model 125 to review plans that that have been recommended to user in a production environment, and the feedback provided can be used to fine-tune the plan recommendation model 125. The subject matter expert review interface 600 includes a control 610, which when clicked on or otherwise activated by the subject matter expert, causes the administrator portal to provide feedback to the model training pipeline 100 indicating that the plan recommendation model 125 correctly suggested one or more plans to the user. The subject matter expert review interface 195 includes a control 605, which when clicked on or otherwise activated by the subject matter expert, causes the administrator portal to provide feedback to the model training pipeline 100 indicating that the plan recommendation model 125 incorrectly suggested one or more plans to the user that were not appropriate based on the user data.

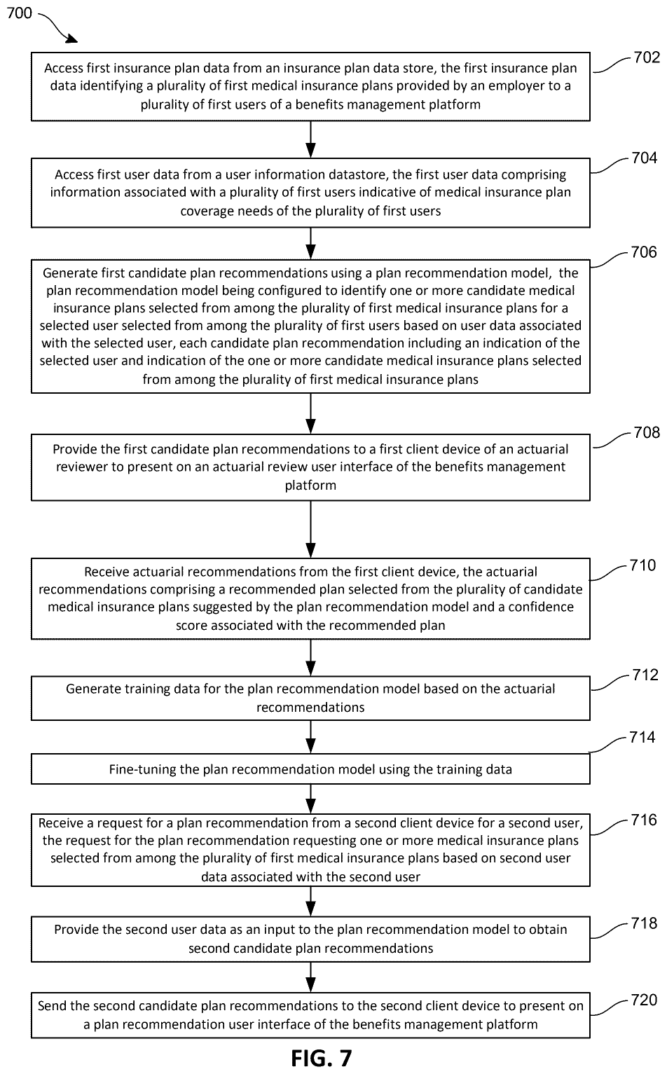

FIG. 7 is a flow chart of an example process 700 for training a plan recommendation model for recommending insurance plans to users according to the techniques disclosed herein. The process 700 can be implemented by the model training pipeline 100 and/or the plan recommendation pipeline 150 as discussed in the preceding examples. The model training pipeline 100 and/or the plan recommendation pipeline 150 can be implemented by the benefits management platform 205 shown in FIGS. 2A and 2B.

The process 700 includes an operation 702 of accessing first insurance plan data from an insurance plan data store. The first insurance plan data identifies a plurality of first medical insurance plans provided by an employer to a plurality of first users of a benefits management platform. The data access unit 105 of the model training pipeline 100 accesses the insurance plan data 107 stored in a persistent datastore that stores medical and/or other types of insurance plans that are provided by an employer. The insurance plan data 107 can be selected by the employer using the employer portal 250 from one or more insurance providers.

The process 700 includes an operation 704 of accessing first user data from a user data datastore, the first user data comprising information associated with a plurality of first users indicative of medical plan coverage needs of the plurality of first users. The data access unit 105 of the model training pipeline 100 accesses the user data 109 stored in a persistent datastore that stores user data for employees who are provided insurance and/or other benefits by their employer. The user data 109 can include information that is provided by the employer, the employee, and/or information obtained from third-party data sources. The employee can access benefits management platform 205 via the employee portal 199. The data access unit 105 can select all or a subset of the user data 109 to be used to train and test the performance of the plan recommendation model 125.

The process 700 includes an operation 706 of generating first candidate plan recommendations using a plan recommendation model 125. The plan recommendation model 125 is configured to identify one or more candidate medical insurance plans selected from among the plurality of first medical insurance plans for a selected user selected from among the plurality of first users based on user data associated with the selected user. Each candidate plan recommendation includes an indication of the selected user and indication of the one or more candidate medical insurance plans selected from among the plurality of first medical insurance plans.

The process 700 includes an operation 708 of providing the first candidate plan recommendations to a first client device of an actuarial reviewer to present on an actuarial review user interface of the benefits management platform. At least a portion of the candidate plan recommendations are analyzed by actuaries to provide feedback on which plans best satisfy the needs of the users. The actuaries can review the candidate plan recommendations using the actuarial labeling user interface 113, which enables the actuaries to provide feedback that is used to label training data that can be used to finetune the plan recommendation model 125.

The process 700 includes an operation 710 of receiving actuarial recommendations from the first client device. The actuarial recommendations comprising a recommended plan selected from the plurality of candidate medical insurance plans suggested by the plan recommendation model and a confidence score associated with the recommended plan. The recommendations input by the actuary or actuaries via the actuarial labeling user interface 113 are received by the data labeling unit 110 of the model training pipeline 100. An example of the actuarial labeling user interface 113 is shown in FIG. 5.

The process 700 includes an operation 712 of generating training data for the plan recommendation model based on the actuarial recommendations. The data labeling unit 110 generates the training data based on the candidate medical plan information and the actuarial recommendations. The data labeling unit 110 can store the labeled training data in the labeled training data storage 115 to enable instances of the plan recommendation model 125 to be finetuned using the labeled training data.

The process 700 includes an operation 714 of fine-tuning the plan recommendation model using the training data. The model training unit 120 uses the trained label data generated by the data labeling unit 110 to improve the performance of the model by training the model to select plans to recommend to a user in a manner that mimics the plans that would be selected by a human actuary. The model training unit 120 can use a portion of the labeled training data to test the performance of the plan recommendation model 125 after the model has been trained using the labeled training data to determine whether the performance of the model better mimics the selections that would have been made by a human actuary given similar user data and insurance plan information. The fine-tuning performed by the model training pipeline can be an iterative process that continues to update fine-tune the performance of the plan recommendation model 125 as additional user data and/or plan data is added. Additional candidate medical plan information can be generated and assessed by actuaries to obtain additional actuarial recommendations that can be used to generate additional training data to further fine-tune the plan recommendation model 125. A technical benefit of this approach is that the plan recommendation model 125 can continue to adapt to changing user needs and plan availability to provide plan recommendations that mimic those that would be recommended by human actuaries given similar data.

The process 700 includes an operation 716 of receiving a request for a plan recommendation from a second client device for a second user. The request for the plan recommendation requesting one or more medical insurance plans selected from among the plurality of first medical insurance plans based on second user data associated with the second user. Once the plan recommendation model 125 has been trained and/or fine-tuned by the model training pipeline, the plan recommendation model 125 can be used to response to requests for plan recommendations for users. The users can request plan recommendations via the employee portal 199 and/or the plan recommendations may automatically be generated for the user in response to the user inputting updates to the user data that change the insurance needs and/or the employer updating the insurance plan data 107 to update the insurance plans and/or other benefits provided to the employees. The plan recommendation pipeline 150 can receive and process the request for the plan recommendations as discussed in the preceding examples.

The process 700 includes an operation 718 of providing the second user data as an input to the plan recommendation model to obtain second candidate plan recommendations and an operation 720 of sending the second candidate plan recommendations to the second client device to present on a plan recommendation user interface of the benefits management platform. The recommendations generated by the plan recommendation pipeline 150 can be provided to the client device of the user. The recommendations can be presented on a user interface the employee portal 199. The plan recommendation pipeline 150 can also assist the user in enrolling in a selected plan as discussed in the preceding examples.

The detailed examples of systems, devices, and techniques described in connection with FIGS. 1-7 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-7 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

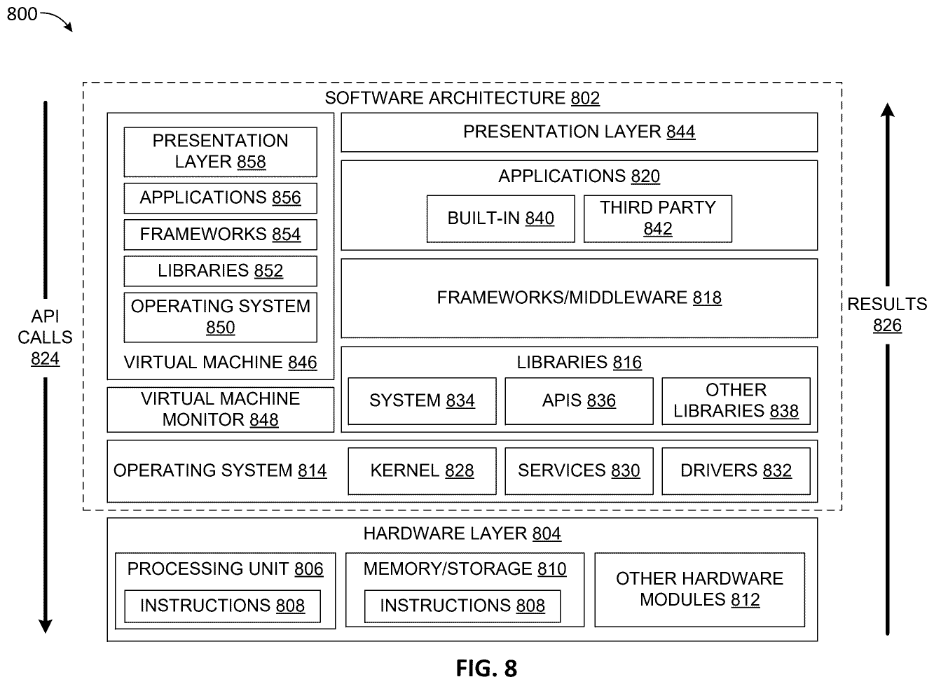

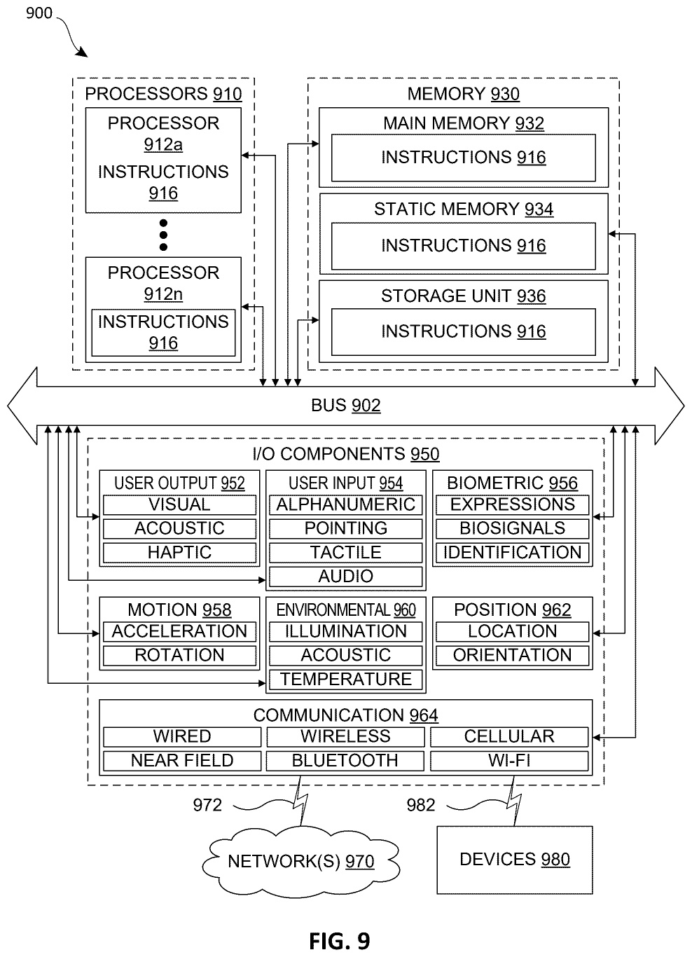

FIG. 8 is a block diagram 800 illustrating an example software architecture 802, various portions of which may be used in conjunction with various hardware architectures herein described, which may implement any of the above-described features. FIG. 8 is a non-limiting example of a software architecture, and it will be appreciated that many other architectures may be implemented to facilitate the functionality described herein. The software architecture 802 may execute on hardware such as a machine 900 of FIG. 9 that includes, among other things, processors 910, memory/storage, and input/output (I/O) components 950. A representative hardware layer 804 is illustrated and can represent, for example, the machine 900 of FIG. 9. The representative hardware layer 804 includes a processing unit 806 and associated executable instructions 808. The executable instructions 808 represent executable instructions of the software architecture 802, including implementation of the methods, modules and so forth described herein. The hardware layer 804 also includes a memory/storage 810, which also includes the executable instructions 808 and accompanying data. The hardware layer 804 may also include other hardware modules 812. Instructions 808 held by processing unit 806 may be portions of instructions 808 held by the memory/storage 810.

The example software architecture 802 may be conceptualized as layers, each providing various functionality. For example, the software architecture 802 may include layers and components such as an operating system (OS) 814, libraries 816, frameworks/middleware 818, applications 820, and a presentation layer 844. Operationally, the applications 820 and/or other components within the layers may invoke API calls 824 to other layers and receive corresponding results 826. The layers illustrated are representative in nature and other software architectures may include additional or different layers. For example, some mobile or special purpose operating systems may not provide the frameworks/middleware 818.

The OS 814 may manage hardware resources and provide common services. The OS 814 may include, for example, a kernel 828, services 830, and drivers 832. The kernel 828 may act as an abstraction layer between the hardware layer 804 and other software layers. For example, the kernel 828 may be responsible for memory management, processor management (for example, scheduling), component management, networking, security settings, and so on. The services 830 may provide other common services for the other software layers. The drivers 832 may be responsible for controlling or interfacing with the underlying hardware layer 804. For instance, the drivers 832 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 816 may provide a common infrastructure that may be used by the applications 820 and/or other components and/or layers. The libraries 816 typically provide functionality for use by other software modules to perform tasks, rather than interacting directly with the OS 814. The libraries 816 may include system libraries 834 (for example, C standard library) that may provide functions such as memory allocation, string manipulation, file operations. In addition, the libraries 816 may include API libraries 836 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 816 may also include a wide variety of other libraries 838 to provide many functions for applications 820 and other software modules.

The frameworks/middleware 818 provide a higher-level common infrastructure that may be used by the applications 820 and/or other software modules. For example, the frameworks/middleware 818 may provide various graphic user interface (GUI) functions, high-level resource management, or high-level location services. The frameworks/middleware 818 may provide a broad spectrum of other APIs for applications 820 and/or other software modules.

The applications 820 include built-in applications 840 and/or third-party applications 842. Examples of built-in applications 840 may include, but are not limited to, a contacts application, a browser application, a location application, a media application, a messaging application, and/or a game application. Third-party applications 842 may include any applications developed by an entity other than the vendor of the particular platform. The applications 820 may use functions available via OS 814, libraries 816, frameworks/middleware 818, and presentation layer 844 to create user interfaces to interact with users.

Some software architectures use virtual machines, as illustrated by a virtual machine 848. The virtual machine 848 provides an execution environment where applications/modules can execute as if they were executing on a hardware machine (such as the machine 900 of FIG. 9, for example). The virtual machine 848 may be hosted by a host OS (for example, OS 814) or hypervisor, and may have a virtual machine monitor 846 which manages operation of the virtual machine 848 and interoperation with the host operating system. A software architecture, which may be different from software architecture 802 outside of the virtual machine, executes within the virtual machine 848 such as an OS 850, libraries 852, frameworks 854, applications 856, and/or a presentation layer 858.

FIG. 9 is a block diagram illustrating components of an example machine 900 configured to read instructions from a machine-readable medium (for example, a machine-readable storage medium) and perform any of the features described herein. The example machine 900 is in a form of a computer system, within which instructions 916 (for example, in the form of software components) for causing the machine 900 to perform any of the features described herein may be executed. As such, the instructions 916 may be used to implement modules or components described herein. The instructions 916 cause unprogrammed and/or unconfigured machine 900 to operate as a particular machine configured to carry out the described features. The machine 900 may be configured to operate as a standalone device or may be coupled (for example, networked) to other machines. In a networked deployment, the machine 900 may operate in the capacity of a server machine or a client machine in a server-client network environment, or as a node in a peer-to-peer or distributed network environment. Machine 900 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 900 is illustrated, the term “machine” includes a collection of machines that individually or jointly execute the instructions 916.

The machine 900 may include processors 910, memory/storage 930, and I/O components 950, which may be communicatively coupled via, for example, a bus 902. The bus 902 may include multiple buses coupling various elements of machine 900 via various bus technologies and protocols. In an example, the processors 910 (including, for example, a central processing unit (CPU), a graphics processing unit (GPU), a digital signal processor (DSP), an ASIC, or a suitable combination thereof) may include one or more processors 912a to 912n that may execute the instructions 916 and process data. In some examples, one or more processors 910 may execute instructions provided or identified by one or more other processors 910. The term “processor” includes a multicore processor including cores that may execute instructions contemporaneously. Although FIG. 9 shows multiple processors, the machine 900 may include a single processor with a single core, a single processor with multiple cores (for example, a multicore processor), multiple processors each with a single core, multiple processors each with multiple cores, or any combination thereof. In some examples, the machine 900 may include multiple processors distributed among multiple machines.

The memory/storage 930 may include a main memory 932, a static memory 934, or other memory, and a storage unit 936, both accessible to the processors 910 such as via the bus 902. The storage unit 936 and memory 932, 934 store instructions 916 embodying any one or more of the functions described herein. The memory/storage 930 may also store temporary, intermediate, and/or long-term data for processors 910. The instructions 916 may also reside, completely or partially, within the memory 932, 934, within the storage unit 936, within at least one of the processors 910 (for example, within a command buffer or cache memory), within memory at least one of I/O components 950, or any suitable combination thereof, during execution thereof. Accordingly, the memory 932, 934, the storage unit 936, memory in processors 910, and memory in I/O components 950 are examples of machine-readable media.

As used herein, “machine-readable medium” refers to a device able to temporarily or permanently store instructions and data that cause machine 900 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 916) for execution by a machine 900 such that the instructions, when executed by one or more processors 910 of the machine 900, cause the machine 900 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 950 may include a wide variety of hardware components adapted to receive input, provide output, produce output, transmit information, exchange information, capture measurements, and so on. The specific I/O components 950 included in a particular machine will depend on the type and/or function of the machine. For example, mobile devices such as mobile phones may include a touch input device, whereas a headless server or IoT device may not include such a touch input device. The particular examples of I/O components illustrated in FIG. 9 are in no way limiting, and other types of components may be included in machine 900. The grouping of I/O components 950 are merely for simplifying this discussion, and the grouping is in no way limiting. In various examples, the I/O components 950 may include user output components 952 and user input components 954. User output components 952 may include, for example, display components for displaying information (for example, a liquid crystal display (LCD) or a projector), acoustic components (for example, speakers), haptic components (for example, a vibratory motor or force-feedback device), and/or other signal generators. User input components 954 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 950 may include biometric components 956, motion components 958, environmental components 960, and/or position components 962, among a wide array of other physical sensor components. The biometric components 956 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 958 may include, for example, acceleration sensors (for example, an accelerometer) and rotation sensors (for example, a gyroscope). The environmental components 960 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 962 may include, for example, location sensors (for example, a Global Position System (GPS) receiver), altitude sensors (for example, an air pressure sensor from which altitude may be derived), and/or orientation sensors (for example, magnetometers).

The I/O components 950 may include communication components 964, implementing a wide variety of technologies operable to couple the machine 900 to network(s) 970 and/or device(s) 980 via respective communicative couplings 972 and 982. The communication components 964 may include one or more network interface components or other suitable devices to interface with the network(s) 970. The communication components 964 may include, for example, components adapted to provide wired communication, wireless communication, cellular communication, Near Field Communication (NFC), Bluetooth communication, Wi-Fi, and/or communication via other modalities. The device(s) 980 may include other machines or various peripheral devices (for example, coupled via USB).

In some examples, the communication components 964 may detect identifiers or include components adapted to detect identifiers. For example, the communication components 964 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 964, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirements of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory storing executable instructions that, when executed, cause the processor alone or in combination with other processors to perform operations of:
accessing first insurance plan data from an insurance plan data store, the first insurance plan data identifying a plurality of first medical insurance plans provided by an employer to a plurality of first users of a benefits management platform;
accessing first user data from a user information datastore, the first user data comprising information associated with a plurality of first users indicative of medical plan coverage needs of the plurality of first users;
generating first candidate plan recommendations using a plan recommendation model, the plan recommendation model being configured to identify one or more candidate medical insurance plans selected from among the plurality of first medical insurance plans for a selected user selected from among the plurality of first users based on user data associated with the selected user, each candidate plan recommendation including an indication of the selected user and indication of the one or more candidate medical insurance plans selected from among the plurality of first medical insurance plans;
providing the first candidate plan recommendations to a first client device of an actuarial reviewer to present on an actuarial review user interface of the benefits management platform,
receiving actuarial recommendations from the first client device, the actuarial recommendations comprising a recommended plan selected from the first candidate plan recommendations suggested by the plan recommendation model and a confidence score associated with the recommended plan;
generating labeled training data for the plan recommendation model based on the actuarial recommendations;
fine-tuning the plan recommendation model using the labeled training data;
receiving a request for a plan recommendation from a second client device for a second user, the request for the plan recommendation requesting one or more medical insurance plans selected from among the plurality of first medical insurance plans based on second user data associated with the second user;
providing the second user data as an input to the plan recommendation model to obtain second candidate plan recommendations; and
sending the second candidate plan recommendations to the second client device to present on a plan recommendation user interface of the benefits management platform.

2. The data processing system of claim 1, wherein the memory further stores executable instructions that, when executed, cause the processor alone or in combination with other processors to perform operations of:
receiving the first user data from a plurality of first client devices of a plurality of first users via a user interface of an employee portal of the benefits management platform; and
storing the first user data in the user information datastore of the benefits management platform.

3. The data processing system of claim 1, wherein the memory further stores executable instructions that, when executed, cause the processor alone or in combination with other processors to perform operations of:
receiving the first insurance plan data from a first client device of the employer via a user interface of an employer portal of the benefits management platform; and
storing the first user data in the insurance plan data store of the benefits management platform.

4. The data processing system of claim 1, wherein to generate the labeled training data for the plan recommendation model, the memory further stores executable instructions that, when executed, cause the processor alone or in combination with other processors to perform operations of:
generating a plurality of labeled samples that include sample user data representing a sample user for which sample plan recommendations were generated, a recommended plan selected from the sample plan recommendations, and a confidence score associated with the recommended plan indicating a confidence in recommending the recommended plan from among the sample plan recommendations.

5. The data processing system of claim 4, wherein the memory further stores executable instructions that, when executed, cause the processor alone or in combination with other processors to perform operations of:
sanitizing the sample user data to remove personally identifiable information from the sample user data.

6. The data processing system of claim 4, wherein the memory further stores executable instructions that, when executed, cause the processor alone or in combination with other processors to perform operations of:
splitting the labeled training data into a first set of labeled training data and a second set of labeled training data;
fine-tuning the plan recommendation model using the first set of labeled training data;
providing the second set of labeled training data as an input to the plan recommendation model to obtain sample plan recommendations; and
comparing the sample plan recommendations to expected plan recommendations included in the second set of labeled training data to evaluate performance of the plan recommendation model.

7. The data processing system of claim 1, wherein the memory further stores executable instructions that, when executed, cause the processor alone or in combination with other processors to perform operations of:
presenting the second candidate plan recommendations on a subject matter expert review interface of an administrator portal of the benefits management platform;
receiving feedback on the second candidate plan recommendations from one or more subject matter experts; and
fine-tuning the plan recommendation model based on the feedback on the second candidate plan recommendations.

8. The data processing system of claim 1, wherein the memory further stores executable instructions that, when executed, cause the processor alone or in combination with other processors to perform operations of:
deploying the plan recommendation model to a production environment after fine-tuning the plan recommendation model using the labeled training data.

9. The data processing system of claim 1, wherein the memory further stores executable instructions that, when executed, cause the processor alone or in combination with other processors to perform operations of:
receiving second user data at the benefits management platform;
generating second candidate plan recommendations based on the second user data;
providing the second candidate plan recommendations to the first client device of the actuarial reviewer;
receiving second actuarial recommendations from the first client device, the second actuarial recommendations comprising a recommended plan selected from the first candidate plan recommendations suggested by the plan recommendation model and a confidence score associated with the recommended plan;
generating second labeled training data for the plan recommendation model based on the actuarial recommendations; and
fine-tuning the plan recommendation model using the second labeled training data.

10. A method for operating a plan recommendation model, the method comprising:
accessing first insurance plan data from an insurance plan data store, the first insurance plan data identifying a plurality of first medical insurance plans provided by an employer to a plurality of first users of a benefits management platform;
accessing first user data from a user information datastore, the first user data comprising information associated with a plurality of first users indicative of medical plan coverage needs of the plurality of first users;
generating first candidate plan recommendations using a plan recommendation model, the plan recommendation model being configured to identify one or more candidate medical insurance plans selected from among the plurality of first medical insurance plans for a selected user selected from among the plurality of first users based on user data associated with the selected user, each candidate plan recommendation including an indication of the selected user and indication of the one or more candidate medical insurance plans selected from among the plurality of first medical insurance plans;
providing the first candidate plan recommendations to a first client device of an actuarial reviewer to present on an actuarial review user interface of the benefits management platform;
receiving actuarial recommendations from the first client device, the actuarial recommendations comprising a recommended plan selected from the first candidate plan recommendations suggested by the plan recommendation model and a confidence score associated with the recommended plan;
generating labeled training data for the plan recommendation model based on the actuarial recommendations;
fine-tuning the plan recommendation model using the labeled training data;
receiving a request for a plan recommendation from a second client device for a second user, the request for the plan recommendation requesting one or more medical insurance plans selected from among the plurality of first medical insurance plans based on second user data associated with the second user;
providing the second user data as an input to the plan recommendation model to obtain second candidate plan recommendations; and
sending the second candidate plan recommendations to the second client device to present on a plan recommendation user interface of the benefits management platform.

11. The method of claim 10, the method further comprising:
receiving the first user data from a plurality of first client devices of a plurality of first users via a user interface of an employee portal of the benefits management platform; and
storing the first user data in the user information datastore of the benefits management platform.

12. The method of claim 10, the method further comprising:
receiving the first insurance plan data from a first client device of the employer via a user interface of an employer portal of the benefits management platform; and
storing the first user data in the insurance plan data store of the benefits management platform.

13. The method of claim 10, wherein generating the labeled training data for the plan recommendation model further comprises:
generating a plurality of labeled samples that include sample user data representing a sample user for which sample plan recommendations were generated, a recommended plan selected from the sample plan recommendations, and a confidence score associated with the recommended plan indicating a confidence in recommending the recommended plan from among the sample plan recommendations.

14. The method of claim 13, the method further comprising:
sanitizing the sample user data to remove personally identifiable information from the sample user data.

15. The method of claim 13, the method further comprising:
splitting the labeled training data into a first set of labeled training data and a second set of labeled training data;
fine-tuning the plan recommendation model using the first set of labeled training data;
providing the second set of labeled training data as an input to the plan recommendation model to obtain sample plan recommendations; and
comparing the sample plan recommendations to expected plan recommendations included in the second set of labeled training data to evaluate performance of the plan recommendation model.

16. The method of claim 10, the method further comprising:
presenting the second candidate plan recommendations on a subject matter expert review interface of an administrator portal of the benefits management platform;
receiving feedback on the second candidate plan recommendations from one or more subject matter experts; and
fine-tuning the plan recommendation model based on the feedback on the second candidate plan recommendations.

17. The method of claim 10, the method further comprising:
deploying the plan recommendation model to a production environment after fine-tuning the plan recommendation model using the labeled training data.

18. The method of claim 10, the method further comprising:
receiving second user data at the benefits management platform;
generating second candidate plan recommendations based on the second user data;
providing the second candidate plan recommendations to the first client device of the actuarial reviewer;
receiving second actuarial recommendations from the first client device, the second actuarial recommendations comprising a recommended plan selected from the first candidate plan recommendations suggested by the plan recommendation model and a confidence score associated with the recommended plan;
generating second labeled training data for the plan recommendation model based on the actuarial recommendations; and
fine-tuning the plan recommendation model using the second labeled training data.

19. A machine-readable medium on which are stored instructions that, when executed, cause a processor of alone or in combination with other processors to perform operations of:
accessing first insurance plan data from an insurance plan data store, the first insurance plan data identifying a plurality of first medical insurance plans provided by an employer to a plurality of first users of a benefits management platform;
accessing first user data from a user information datastore, the first user data comprising information associated with a plurality of first users indicative of medical plan coverage needs of the plurality of first users;
generating first candidate plan recommendations using a plan recommendation model, the plan recommendation model being configured to identify one or more candidate medical insurance plans selected from among the plurality of first medical insurance plans for a selected user selected from among the plurality of first users based on user data associated with the selected user, each candidate plan recommendation including an indication of the selected user and indication of the one or more candidate medical insurance plans selected from among the plurality of first medical insurance plans;
providing the first candidate plan recommendations to a first client device of an actuarial reviewer to present on an actuarial review user interface of the benefits management platform;
receiving actuarial recommendations from the first client device, the actuarial recommendations comprising a recommended plan selected from the first candidate plan recommendations suggested by the plan recommendation model and a confidence score associated with the recommended plan;
generating labeled training data for the plan recommendation model based on the actuarial recommendations;
fine-tuning the plan recommendation model using the labeled training data;
receiving a request for a plan recommendation from a second client device for a second user, the request for the plan recommendation requesting one or more medical insurance plans selected from among the plurality of first medical insurance plans based on second user data associated with the second user;
providing the second user data as an input to the plan recommendation model to obtain second candidate plan recommendations; and
sending the second candidate plan recommendations to the second client device to present on a plan recommendation user interface of the benefits management platform.

20. The machine-readable medium of claim 19, wherein the machine-readable medium further stores executable instructions that, when executed, cause the processor alone or in combination with other processors to perform operations of:
generating a plurality of labeled samples that include sample user data representing a sample user for which sample plan recommendations were generated, a recommended plan selected from the sample plan recommendations, and a confidence score associated with the recommended plan indicating a confidence in recommending the recommended plan from among the sample plan recommendations.
